(19) United States
(12) Patent Application Publication
(10) Pub. No.: US 2005/0022104 A1
(43) Pub. Date: Jan. 27, 2005

(54) Method and system for automating the production of publications

(75) Inventors: Ronald Wrenholt, Chanhassen, MN (US); Yusup Hartato, Shakopee, MN (US); Vincent Dominguez, St. Paul, MN (US); Kanwal Kumar, Eagan, MN (US); Wilianto Widjaja, St. Paul, MN (US); Cherry Fan, Edina, MN (US); Thang Huynh, Brooklyn Park, MN (US); Glenn Bottomly, Fridley, MN (US)

Correspondence Address: NIKOLAI & MERSEREAU, P.A., 900 SECOND AVENUE SOUTH, SUITE 820, MINNEAPOLIS, MN, 55402, US

(73) Assignee: Lifetouch, Inc., Eden Prairie, MN (US)

(21) Appl. No.: 10/624,207

(22) Filed: Jul. 22, 2003

(51) Int. Cl. G06F 15/00

(52) U.S. Cl. 715/500; 715/530

(57) ABSTRACT

Automation of the process of creating pages for publications is achieved by developing on a publisher's computer a database including images and data related to the images. The data are used to select, sort and organize the images on page layouts based upon instructions from an authorized user from that user's computer.

### BACKGROUND OF THE INVENTION

I. Field of the Invention

The present invention relates to the production of publications containing large numbers of images. Such publications include yearbooks, directories, memory books, calendars, special event publications and a variety of other types of publications. More specifically, the present invention relates to a system and method for automating page layout, editing, proofing and printing of publication pages.

II. Description of the Prior Art

Many organizations publish books and other items containing large numbers of photographs. Many schools, for example, publish annual yearbooks. School yearbooks typically contain (i) portrait photographs of students, teachers and staff; (ii) candid photographs taken at events throughout the year; and (iii) text and other graphics. Creating a high quality yearbook has, in the past, been a very labor-intensive task both on the part of the organization sponsoring the yearbook and on the part of the yearbook publisher.

Schools often enlist a cadre of students to help with the production of yearbooks. Some of the work allows students to be very creative. This creative work includes taking candid photographs that capture the flavor of school events. This creative work also includes writing text. Other tasks are equally important in producing a high quality yearbook, but tend to be time consuming and mundane. One of these tasks is the assembly of portrait pages for a yearbook.

The assembly of yearbook portrait pages has historically taken months to complete. First, portrait photographs of each student, teacher and staff member had to be taken. Picture proofs of each portrait then had to be printed. The proofs had to be reviewed for quality and new pictures taken if there was any problem with the photograph. The image of the person might not be centered in the photograph. The image of the person might be too big or too small. There may be issues with coloration. After the portrait pictures were retaken, proofs of the retakes had to be printed and checked for quality.

Once the yearbook staff had received the proofs and was satisfied with the quality of all the photographs, the staff had to make an important decision related to grouping. Would the photographs be grouped by grade, by homerooms, by teacher, or in some other way? Only after this decision was made, could the laborious process of sorting the photographs into groups take place. Sorting photos for a school of fifteen hundred students by homerooms of twenty-five students each would result in sixty different groups. Once grouped, the proofs would have to be placed in the correct order, usually alphabetical. Further, the name of each student shown had to be associated with each photograph.

After the proofs were grouped, the groups were put in order and the names were associated with the photographs, the proofs were returned to the yearbook publisher. The publisher would then create page layouts and create page proofs. The page proofs were provided to the school to be checked. Errors were common. Distance and communication issues made it difficult to articulate what was desired with respect to the page layouts. Communicating what portraits, candid shots and text should appear together on a given page often proved to be difficult. Any errors or miscommunication resulted in a great deal of work both for the school and for the yearbook publisher. Only after all the page proofs were acceptable could actual printing of the yearbook begin.

Similar processes have been used in the creation of other publications containing a variety of photographs and other images.

### SUMMARY OF THE INVENTION

The present invention streamlines and automates the process outlined above. In doing so, it offers several advantages that greatly improve the quality of the publication and the efficiency with which publications can be produced.

The process of the present invention begins with the taking or collection of the photographs. At the time the photographs are taken or collected, data is assembled and associated with each photograph. When a school yearbook is being published, the data include among other things the person's name, the person's grade, the person's homeroom, and the person's teacher identifier. The data collected also indicates whether the person is a student, a teacher, or staff member.

During processing of the photographs, a database is created. The database includes at least one image file for each photograph taken and data tables that store the data and associate the data with the image files. The image files typically are quite large and offer a high resolution of the photograph for printing. The files are then converted into low-resolution versions of the same file for electronic transmission between the publisher's computer and a computer owned by the institution sponsoring the publication.

Electronic storage and transmission of the data and image files and the widespread availability of the Internet are key advances which, in combination with other features of this invention, eliminate the need to print proofs at the production plant and mail them to the institution sponsoring the publication. The present invention contemplates that once the database has been created, an e-mail message is sent to the institution. The institution can then access the database using a secure Internet connection to edit the data, edit the images, as well as organize the low-resolution digital image files into different groupings. Photos can be cropped and otherwise adjusted electronically. All of this can be done in a paperless fashion.

Also, the institution can transmit to the publisher for storage in the database electronic image files of candid photographs taken, for example, by the yearbook staff and data associated with such photographs. These image files can be in any standard format, JPEG being just one example. These image files and data are added to the database.

Not only is proofing of text and images streamlined, designing pages for the publication is as well. Through an Internet connection to the publisher's computer, an authorized user can select (i) a page layout from a series of templates; (ii) a photo size; and (iii) a sort method. In the case of a school yearbook, the typical grouping would be by grade, homeroom, or teacher. The system then calculates the number of pages required given the selections made. If the number of pages is acceptable, the user confirms the selections and the system automatically groups the pictures, puts them in the correct order and creates a draft layout of the pages. The draft layout includes low-resolution versions of the photographs as well as any associated text and graphics. The pages are immediately electronically saved as a PDF file, a JPEG file and/or in any other suitable file format and automatically transmitted electronically to the user. These steps, which formerly took weeks and required hundreds of hours of staff time to complete when performed manually, are all completed in less than a few minutes.

Once the user receives the electronic “page proofs”, the page proofs can be edited. Candid pictures, text and graphics can also be added. If the user does not like the results, the page layout steps can be repeated using a different layout template, portrait size or sort specification. When the user is satisfied, the pages are submitted electronically to the yearbook publishing plant for printing. The time saved can be put to far more creative use and publishing of the work is far less expensive.

From the foregoing, it should be clear that the present invention offers various advantages and meets various objectives when used in publishing any of a variety of publication types. The objects of the invention, by way of example, can be understood in the context of yearbook publishing as follows:

One object of the present invention is to improve the quality of publications.

A second object of the present invention is to reduce the time required to create portrait pages for publications.

A third object of the present invention is to improve communications between a school's yearbook staff and the yearbook publisher to ensure that the yearbook produced is of a high quality.

A fourth object is to enhance the ability to proof and check photographs and text to be used in the yearbook.

A fifth object is to enhance the capability to edit data, text, and the photographs and other images as well.

A sixth object is to reduce from weeks or even months to just minutes, the time required to design portrait pages for the yearbook.

A seventh object of the invention is to give a school's yearbook staff greater creative control over the layout and content of yearbook pages.

An eighth object of the invention is to automate the laborious tasks of grouping portrait photographs and then placing the photographs in the correct order thus freeing up time for the yearbook staff to engage in other, more creative work.

Thus, a ninth object of the present invention is to improve the quality of the educational experience of student members of a yearbook staff.

A tenth object of the present invention is to enable schools with computers having limited processing power and storage capabilities to use the more expensive computing resources of the publisher without having to travel to the publisher's location.

An eleventh object of the invention is to provide the yearbook staff the opportunity to proofread and edit electronically.

A twelfth object of the invention is to reduce the paper, printing and mailing costs associated with the creation of a yearbook.

A thirteenth object of the invention is to achieve each of the foregoing objectives and also permit portrait pages of a yearbook to include not only professional portraits, but also candid photographs, text, graphics, or the like created by students.

A fourteenth object of the invention is to enable students on a yearbook staff to take advantage of all of the foregoing advantages of the invention using virtually any computer having an Internet connection and standard Internet browser software.

A fifteenth object of the invention is to increase transmission speeds over the Internet through the use of low resolution images which are replaced at the time of actual printing of the yearbook with high resolution photographs.

A sixteenth object of the invention is to provide adequate security so that only authorized members of a school's yearbook staff and the publisher's staff can gain access to the electronic databases associated with that school's yearbook.

These and other objects of the invention, including those related to other publication types, will become clearer from a reading of the following detailed description of the preferred embodiment in view of the drawings that also form a part of this specification. The present invention offers many advantages in connection with the creation of various types of publications. To meet the disclosure requirements of the patent laws, a best mode of the invention is described in the context of the publication of yearbooks. This is not intended to be limiting, but rather is intended to provide one of many examples where the present invention is highly advantageous.

### BRIEF DESCRIPTION OF THE DRAWINGS

FIG. 1 is a schematic diagram of the equipment used with the present invention.

FIG. 2 is an example data model that can be used with the present invention.

FIG. 3 is a sample yearbook page created using the present invention.

FIG. 4 is a flow chart showing the process of the present invention.

FIG. 5 is a sample page template matching the yearbook page shown in FIG. 3.

FIG. 6 is a graphical representation of an XML snipit of the type used based upon the selection of the page layout shown in FIG. 5.

FIG. 7 is a portrait panel snipit for the page of the yearbook shown in FIG. 3.

### DETAILED DESCRIPTION OF THE PREFERRED EMBODIMENTS

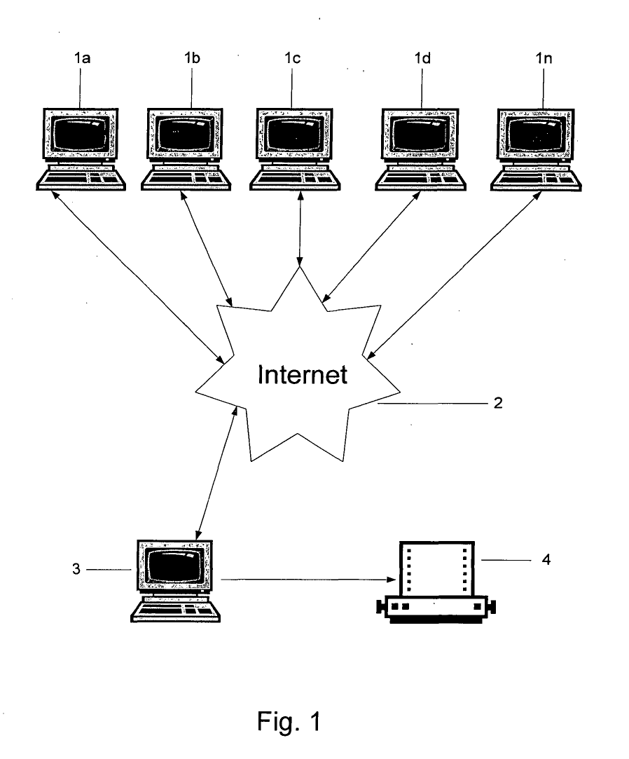

As shown in simplified form in FIG. 1, the present invention includes a series of computers 1a-1n. These computers can be separately located at various institutions desiring to produce a publication. Each of these computers is connected to the Internet 2. The computers 1a-1n can be virtually any personal computer. These computers will typically have a keyboard, mouse and monitor. They also are preferably equipped with a web browser and connected to the Internet. Ideally, the computers 1a-1n will also be connected to a printer for printing proof pages and to a scanner for scanning candid photographs, graphics or the like created by the institution's staff. Of course, digital cameras can be used to create the images in which case a scanner may not be necessary. While not necessary, desktop publishing software, such as Adobe® PageMaker®, could also be loaded on the computers 1a-1n.

FIG. 1 also shows a production computer system 3. The production computer system 3 is operated by the publishing company and consists of one or more computers that are located as desired by the publishing company. The bulk of storage and processing will take place on production computer system 3. Production computer system 3 will ideally have mass storage capabilities and sufficient memory and processing power for high-speed manipulation and processing of large quantities of data.

As FIG. 1 suggests, a number of different schools or other institutions a-n can have computers capable of connecting with the production computer system 3 over the Internet 2. None of these computers has complete access to all of the data stored on the production computer system 3. Instead, separate database entries are created for each institution. Each such database includes an electronic image file for each photograph and data tables linking each of the image files to data related to the photograph. Such data includes at a minimum a text identification of what is shown in the photograph and data related to that photograph that will be used to sort the photos. When the photograph is of a person, the text identification will typically be the person's name. For school yearbooks, the data used for sorting would typically include the person's grade, homeroom and/or teacher.

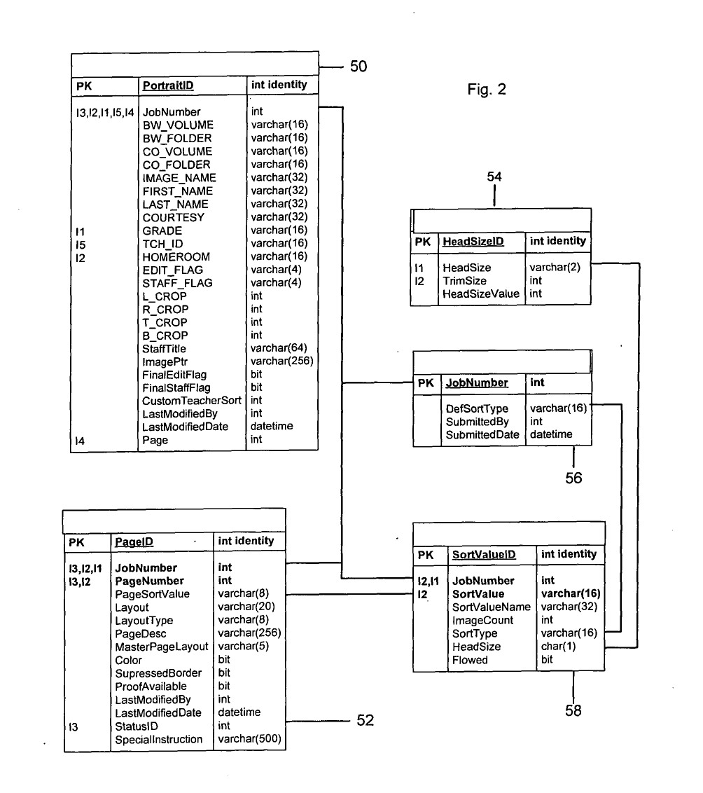

FIG. 2 is a table showing how these and other data can be stored in a relational database for use in publishing a school yearbook. The relational database shown in FIG. 2 consists of five tables in which these data are stored. Table 50 stores data related to a separate portrait photograph taken of each student, teacher and staff member of a school. Such data include the job number for the yearbook to be published. Such data also include information related to where the specific photographs are stored in the database. Both a black and white version and a color version of each photograph can be stored. In both cases, each photograph is stored by a unique image name in a folder of a volume. For each photograph, table 50 lists not only the image name of the photograph, but also the volume and folder in which a black and white version is stored and the volume and folder in which the color version is stored.

To identify the person shown in each of the photographs, table 50 also includes the first and last names of the person as well as a “courtesy” or title (e.g., Mr., Ms., Professor, Dr., etc.). These fields are used not only to alphabetize groups of photos by name, but also in listing the names of the people shown on a yearbook page. Such data can be used not only to place pictures in the correct order, but also automatically create text captions for the photographs to be printed in the publication along with the photographs.

To assist in sorting photographs, several additional pieces of data are included in table 50 for each photograph. These include the person's grade, the person's teacher ID, and the person's homeroom. The table can also be used to record whether the person is a student or staff member in the “staff-flag” field. If the person is a staff member, the person's title is included in the “staff title” field.

The system of the present invention contemplates that the photographs can be cropped or otherwise edited by either the staff of the publisher or the staff of the institution sponsoring the yearbook. Editing by the yearbook staff of the institution is performed on-line from a computer 1. Table 50 of the database therefore includes left, right, top and bottom cropping fields so such cropping information can be recorded and stored. Other editing and status fields are provided as well in table 50.

Table 52 is used to record data related to yearbook pages. The job number is included in this table. Also, a unique page number is included to identify the page. Other data recorded in this table relates to the layout, whether it is a color or black and white page, and whether borders should be shown and printed.

Tables 54, 56 and 58 are used in combination with the layout information in table 52 and the portrait information in table 50 to automate the development of portrait pages. Table 54 is used to record information related to picture sizes that can be used. Tables 56 and 58 are used to record information related to sorting.

One benefit of a relational database is that it can be easily tailored to meet the needs of the publisher and the institutions sponsoring yearbooks or other types of publications. The types of data stored and associated either with portrait photos or pages can by expanded or contracted depending on the particular needs.

The database can include other types of data as well, such as digital files uploaded to the database by members of the yearbook staff using the computer 1. Such data can be in the form of electronic files reflecting candid photographs taken by the yearbook staff, text related to such photograph (i.e., identifying the people or event depicted), graphics files or other text files.

Appropriate security measures are employed to ensure that only authorized persons have access to a particular database. People given access are typically limited to the particular institution's yearbook staff and the staff of the yearbook publisher. Such security measures require a user to log in by identifying the job number for the yearbook, a user name and password.

Prior to the present invention, photographs taken and data generated by the publisher had to be printed by the publisher and mailed to the school. The school would then proof these materials identifying unacceptable photographs and errors in the data. These problems and errors had to be communicated to the publisher by the yearbook staff. With the present invention, the publisher simply sends an e-mail to the school once the photos and data have been added to the database. The yearbook staff can then log into the database and proof the photos and data online. Corrections to the data can be made immediately. Also, the photos can be cropped, centered, scaled or the like online. Such changes are stored directly to the institution's database on the publisher's computer 3. To reduce transmission time, low-resolution versions of the photographs are transmitted. Any change made to the low-resolution version by the yearbook staff is also automatically made to the high-resolution version of that photograph be used for printing.

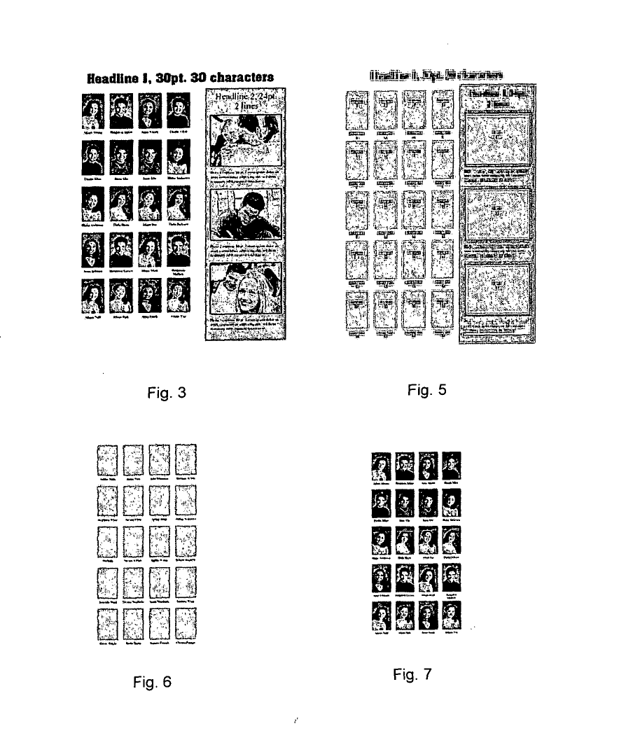

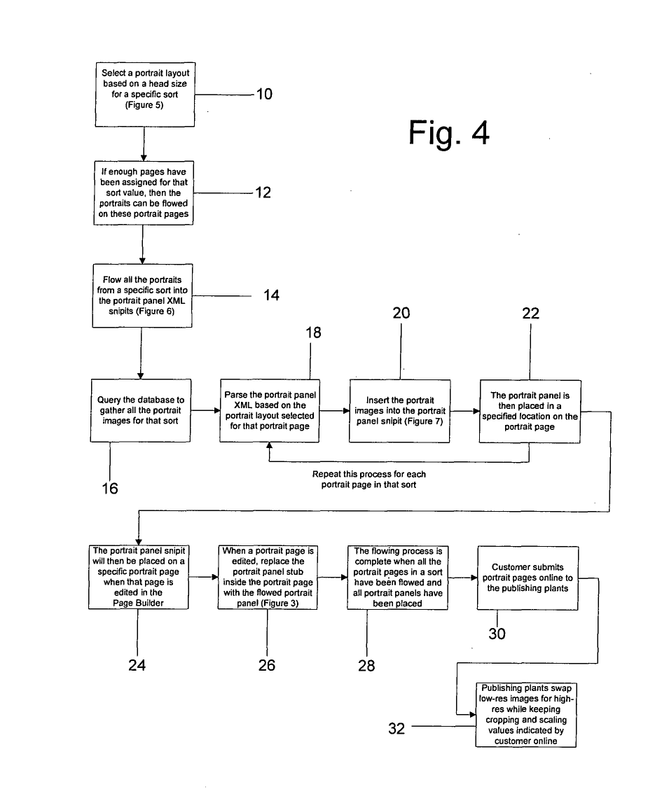

After the text and data have been checked, pages for the publication can be assembled. FIGS. 3 through 7 are provided to help explain how, for example, portrait pages of the type shown in FIG. 3 can be created. A flow chart of this process for creating these page layouts is shown in FIG. 4.

After logging on to the database, the first step 10 of the process requires that the user, typically a member of the institution's yearbook staff, select a portrait layout. FIG. 5 is just one example of the available layouts. The choice of the layout shown in FIG. 5 will result in pages that look like FIG. 3. The layout choice is, to some extent, a matter of taste. However, the layout selection is one of the factors that will dictate the number of portrait pages that will be required.

The layout chosen is stored in table 52 of the database. The user also selects a particular picture or head size that is stored in table 54 of the database. The user then selects a specific sort. The sort information is stored in tables 56 and 58. For school yearbooks, the sort selected to create portrait pages is typically either by grade, by homeroom or by teacher identification. The user can also indicate the number of pages budgeted for the portrait section of the yearbook.

At step 12, computer 3 accesses the database and using data contained therein calculates the number of pages required if the selected layout, head size and sort are used. Computer 3 then sends a message back to computer 1 indicating whether enough pages have been assigned given the layout and sort selections made by the user. If enough pages have been budgeted or assigned, the user can send a message back instructing the computer 3 to move on to step 14. If not enough pages have been assigned, the user can return to step 10 and select an alternative layout or sort. For example, a layout that uses a smaller size for the photographs (referred to as head size in FIGS. 2 and 4) will result in a lower number of pages being required. Alternatively, the user can increase the number of pages assigned. In either event, once the number of pages is acceptable, at step 12 a message is sent from computer 3 to computer 2 causing the processes to proceed to step 14.

At step 14, the computer 3 creates an XML snipit (FIG. 6) based upon the selected layout and sort order. At step 16, computer 3 accesses the database to gather the portrait images based upon the sort. For example, if the photographs are to be sorted by grade, the computer 3 groups the photographs based upon the grade data in table 50 associated with each photograph. The computer 3 then puts the photographs in alphabetical order using the last and first name date fields of table 50. The portrait panel XML is parsed at step 18 based upon the layout selected. At step 20, the portrait images are inserted in the portrait panel snipit. Steps 18-22 are repeated until all the photographs have been placed in the correct group and in the correct order in the group. Once this process is completed, a separate portrait panel snipit exists for each page. FIG. 7 is an example of a portrait panel snipit corresponding to the layout shown in FIG. 5. The portrait panel snipit for each page is saved as both a JPEG and a PDF file.

At step 24, the portrait panel snipit for each page is then placed on the specific portrait page. See FIG. 3. Each page can then be proofed and edited. Candid photographs, text or other graphics can be added as part of an editing process at step 26 to create a final page (see FIG. 3). At step 28, these steps are repeated for the rest of the pages. Steps 24-28 can be performed either on computer 1 using browser software or computer 3 using desktop publishing software like Adobe® PageMaker®.

Once the yearbook staff is satisfied with the pages, at step 30 they are “submitted” electronically to the publisher. This is typically done via the Internet connection. The pages can also be submitted by storing the pages on any suitable portable storage media and then sending the storage media to the publisher when steps 24-28 are performed on computer 1 using desktop publishing software. At step 32, the computer 3 swaps the low-resolution images transmitted between computers 1 and 3 for high-resolution images that will be used for printing. When this is done, all cropping, scaling and other edits of the images performed by the user on the low-resolution images are retained. More specifically, scaling values, cropping values and other editing values indicated on the low-resolution images are applied to the high-resolution images as part of the step of changing the low-resolution images to high-resolution images.

The pages can then be printed on the printer 4 attached to computer 3.

Using the present invention, the steps outlined in FIG. 4 take only a matter of minutes to complete and the completed pages are ready for printing. Getting to this point using old methods and processes formerly took months to complete. This dramatic reduction in time offers several advantages. First, the user can try various alternatives in terms of sort and page layout to see which works and looks best. Second, the user can again proof the furnished pages and make corrections, again without undue delay. Third, the user can share his or her work with the staff of the publisher and get ideas for improvement. Fourth, the time spent can be put to better use taking photographs, writing text and engaging in other creative activities.

While the discussion set forth above relates specifically to yearbook publishing, the present invention relates to publishing in general. Similar advantages are derived from application of the present invention to the publication of directories, calendars, memory books, special event publications, and the like. Virtually any publication containing a significant number of photographs that need to be grouped or sorted can be prepared in an advantageous fashion using the present invention. Thus, the foregoing discussion is not intended to be limiting. The scope of the invention is limited only by the following claims.

1. A method for creating pages for a publication comprising:
a. assembling a collection of images to appear in the publication;
b. collecting data related to the images;
c. creating a database linking the images collected to the data related to the images and storing said images and said database on a first computer system;
d. using one of a plurality of second computers at location remote from said first computer system to access said database;
e. using one of said second computers to select and communicate to said first computer (i) the desired page layout for at least one page of a publication; and (ii) the desired manner in which the images should be grouped;
f. using said first computer system to create and store as a file a panel for said at least one page of the publication based upon the desired page layout and manner in which the images should be grouped, said file containing low-resolution versions of said images;
g. using one of said computers to place said panel into a page and communicating to said first computer system that said page is acceptable;
h. using said first computer system to modify the acceptable page by changing the low-resolution images to high-resolution images; and
i. printing said modified page as part of the printing of the publication.

2. The method of claim 1 wherein data stored in the database is used to automatically create captions for the photographs.

3. The method of claim 1 wherein said publication is a yearbook.

4. The method of claim 1 wherein said publication is a directory.

5. The method of claim 1 wherein said publication is a calendar.

6. The method of claim 1 wherein said publication is a special event publication.

7. The method of claim 1 wherein said database is a relational database.

8. The method of claim 1 wherein said images are photographs.

9. The method of claim 1 wherein cropping values indicated on the low-resolution images are applied to the high-resolution images as part of the step of changing the low-resolution images to high-resolution images.

10. The method of claim 1 wherein scaling values indicated on the low-resolution images are applied to the high-resolution images as part of the step of changing the low-resolution images to high-resolution images.
